(19) United States
(12) Patent Application Publication
(10) Pub. No.: US 2026/0178170 A1
(43) Pub. Date: Jun. 25, 2026

(54) SYSTEMS AND METHODS FOR THE AUTOMATED GENERATION OF CUSTOM MEDIA CONTENT AND CORRESPONDING TEXT

(71) Applicants: Charles Cook, Goleta, CA (US); Jake Robson, Haslingfield (GB)

(72) Inventors: Charles Cook, Goleta, CA (US); Jake Robson, Haslingfield (GB)

(21) Appl. No.: 19/428,304

(22) Filed: Dec. 22, 2025

Related U.S. Application Data
(60) Provisional application No. 63/737,561, filed on Dec. 20, 2024.
(60) Provisional application No. 63/874,636, filed on Sep. 3, 2025.

(51) Int. Cl. G06F 3/0483; G06F 3/0482; G06F 3/04845

(52) U.S. Cl. CPC G06F 3/0483; G06F 3/0482; G06F 3/04845

(57) ABSTRACT

Embodiments include systems, methods, and interfaces for generating a multi-page book customized to a user specified subject. The systems, methods and interface include instructions and displays for providing an interface adapted to prompt the user to supply data specific to the user specified subject, generating and rendering pages of the book based on the data concurrently in parallel while displaying an interface depicting placeholders for each image of the different pages with progress animations, updating dynamically in real-time the placeholders concurrently as image data is processed in parallel, and providing an interface to edit the pages once rendered.

### PRIORITY

The present application claims priority to U.S. Provisional Patent Application No. 63/737,561 filed Dec. 20, 2024 and U.S. Provisional Patent Application No. 63/874,636 filed Sep. 3, 2025. The entirety of both provisional applications are incorporated herein by reference for all purposes.

### FIELD

The present technology relates to various systems and methods for automatically generating customized media (e.g., graphics, photographs, images, video, animations, audio/video books, hardcopy books, etc.) and corresponding text (e.g., stories, copy, written materials, manuals, etc.).

### BACKGROUND

Book generation software systems that leverage artificial intelligence (AI) to allow users to create books are commercially available. For example, companies such as RocketWriter, BriBooks, Nola and Fortelling offer software systems that accept book specifications from users and then use AI to write a book based on the specification. These systems generally write the books for the users and the users only influence the book generation based upon the initial prompts or revised prompts. Unfortunately, these systems do not easily facilitate creation of stories with images in a wholistic manner wherein the users can visualize all parts of the story coming together concurrently. In general, each of these systems provide very disjointed and serial experiences more suitable for technical writing than for creative writing. Thus, what is needed are systems and methods adapted to help users create stories that include images wherein the pages or scenes of the story are each concurrently displayed as the story is being developed.

### SUMMARY

Embodiments include methods of generating a multi-page book customized to a user specified subject. The methods include providing an interface adapted to prompt the user to supply data specific to the user specified subject, generating and rendering pages of the book based on the data concurrently in parallel while displaying an interface depicting placeholders for each image of the different pages with progress animations, updating dynamically in real-time the placeholders concurrently as image data is processed in parallel, and providing an interface to edit the pages once rendered.

Embodiments further include computer-implemented systems for generating a multi-page book customized to a user specified subject. The systems include a processor adapted to execute instructions and a memory coupled to the processor and adapted to store instructions. The instructions are adapted to provide an interface adapted to prompt the user to supply data specific to the user specified subject, generate and render pages of the book based on the data concurrently in parallel while displaying an interface depicting placeholders for each image of the different pages with progress animations, update dynamically in real-time the placeholders concurrently as image data is processed in parallel, and provide an interface to edit the pages once rendered.

Yet further embodiments include user interfaces for generating a multi-page book customized to a user specified subject. The user interfaces include a display adapted to prompt the user to supply data specific to the user specified subject, a display depicting pages of the book rendered based on the data concurrently in parallel while displaying an interface depicting placeholders for each image of the different pages with progress animations, a display of the placeholders that is dynamically updated in real-time concurrently as image data is processed in parallel, and an interface to edit the pages once rendered.

### BRIEF DESCRIPTION OF THE DRAWINGS

FIG. 1 depicts a screenshot of an example of a Character Story Details user interface according to some embodiments.

FIG. 2 depicts a screenshot of an example of a User Character Library interface according to some embodiments.

FIG. 3 depicts a screenshot of an example of a Select/Build Character user interface according to some embodiments.

FIG. 4 depicts a screenshot of an example of an Upload Reference Image user interface according to some embodiments.

FIG. 5 depicts a screenshot of an example of a Generate Character module according to some embodiments.

FIG. 6 depicts a screenshot of a first example of a Story Builder user interface according to some embodiments.

FIG. 7 depicts a screenshot of a second example of a Story Builder user interface according to some embodiments.

FIG. 8A depicts a screenshot of a first example of a Page View user interface according to some embodiments.

FIG. 8B depicts a screenshot of a second example of a Page View user interface according to some embodiments.

FIG. 9 depicts a screenshot of an example of a Text Editor user interface according to some embodiments.

FIG. 10 depicts a screenshot of an example of an Image Editor user interface according to some embodiments.

FIG. 11 depicts a screenshot of an example of an Image Library user interface according to some embodiments.

FIG. 12 depicts a screenshot of an example of a Flip Book/Purchase Book module according to some embodiments.

FIG. 13 depicts a screenshot of an example of a Flip Book user interface according to some embodiments.

FIG. 14 depicts a screenshot of an example of a View My Library user interface according to some embodiments.

FIG. 15 depicts a first part of a flow chart that illustrates an example method of building a story according to some embodiments.

FIG. 16 depicts a second part of a flow chart that illustrates an example method of building a story according to some embodiments.

### DETAILED DESCRIPTION

In various embodiments, the system can include, and/or the method can be performed by, one or more electronic computers or computing devices that implement the various functions described herein under the control of program modules stored on one or more non-transitory computer storage devices (e.g., hard disk drives, solid state memory devices, etc.). Each such computer or computing device typically includes a hardware processor and a memory. Where the system includes multiple computing devices, these devices may, but need not, be co-located. In some cases, the system may be implemented on cloud-based or shared computing resources that are allocated dynamically. The processes and algorithms described herein may alternatively be implemented partially or wholly in application-specific circuitry, such as Application Specific Integrated Circuits and Programmable Gate Array devices. The results of the disclosed processes and process steps may be stored, persistently or otherwise, in any type of non-transitory computer storage such as, e.g., volatile or non-volatile storage.

In some embodiments, the system can receive various information related to a subject's age, appearance, circumstances (e.g., history, health, family, ethnicity, siblings, location), and/or otherwise from the storage element and/or as user inputs. In some implementations, the storage element includes one or more memory devices, such as flash memory, magnetic disk memory, networked or cloud-based memory, or otherwise. The storage element can store the information in a variety of forms, such as in a database.

The user input can be provided to the system via a user interface. In some embodiments, the user interface includes a graphical user interface, such as an interface implemented on a special or general purpose computer. In some implementations, the user interface may include a web-browser. In certain variants, the user interface includes a keypad and/or buttons operated by the user.

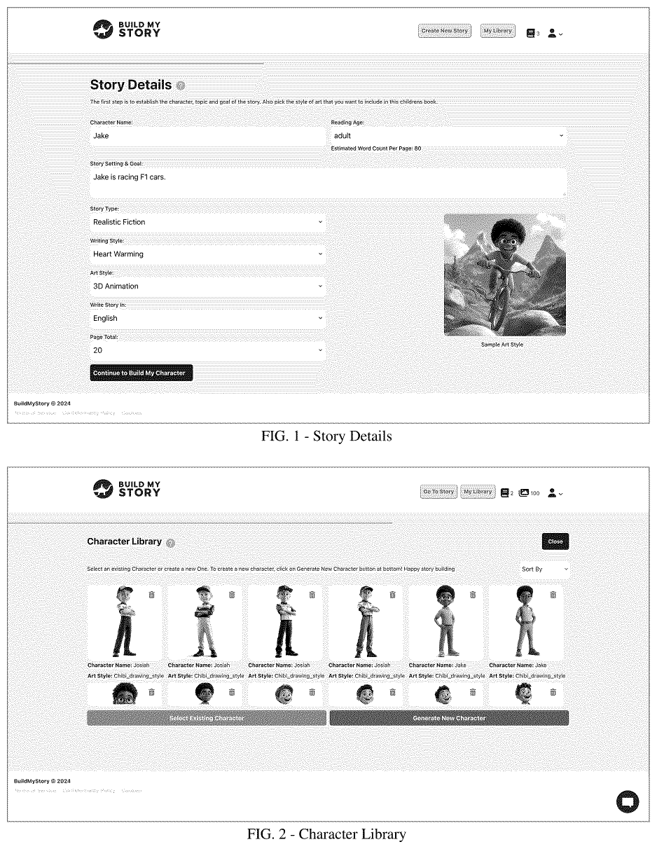

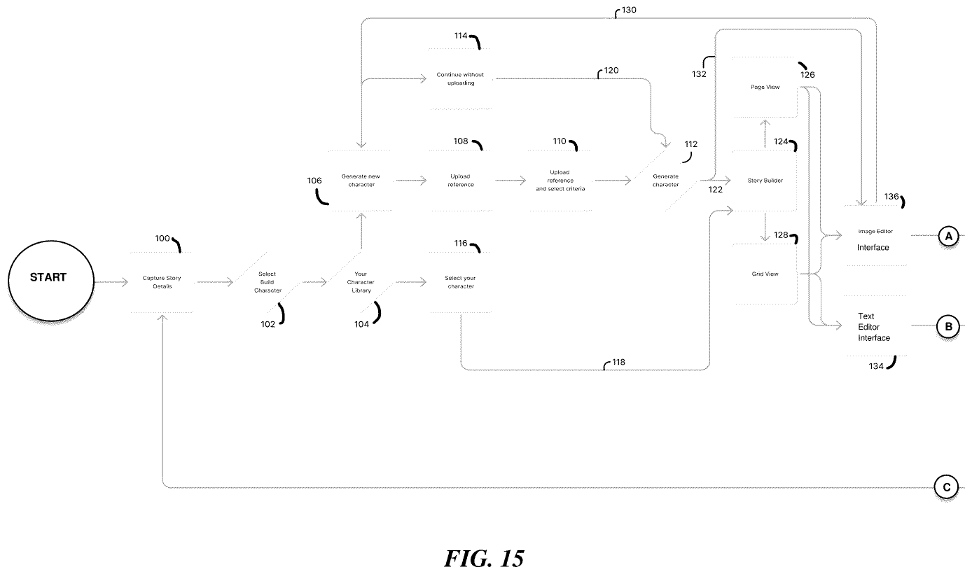

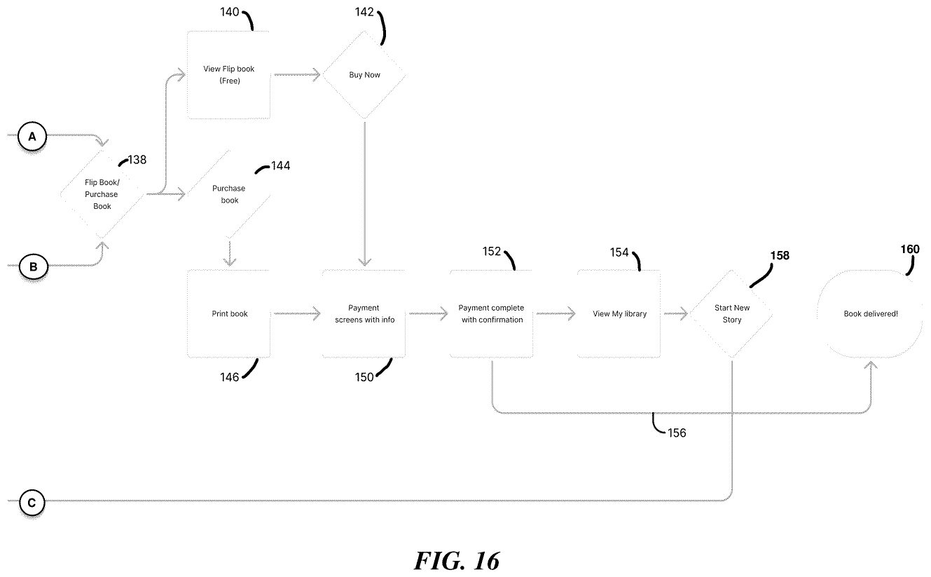

With reference to FIGS. 15 and 16, a flowchart depicting an example method according to embodiments of the invention is shown. Each depicted process step or element is described in FIGS. 1 though 14 using a screenshot of the user interface pages corresponding to the flowchart process steps and elements.

Turning to FIG. 1, a Character Story Details user interface 100 is provided to capture primary story-building details through an intuitive input system. Users provide information such as Story Setting & Goal (free input), Character Name, Reading Level, Story Type, Writing Style, Art Style, Language, and Children's Book Page Total. These details dynamically update the master prompt, which combines structured inputs like story details and art styles to guide downstream processes. The master prompt is optimized using a generative AI's settings, such as, for example, ChatGPT's settings (ChatGPT is an example of a ChatBot-based AI commercially available from OpenAI, L.L.C., a Delaware company). Such settings include temperature for creative flexibility, top_p for broad exploration, and penalties for controlling repetition and concept introduction. These settings ensure relevant and accurate output tailored to the user's specifications.

Turning to FIG. 2, the User Character Library 104 provides centralized storage for previously created characters. Users can sort characters by date, edit, or delete them as needed. This ensures efficient navigation and allows seamless reuse of characters in multiple stories. Selected characters integrate directly into the current story-building workflow.

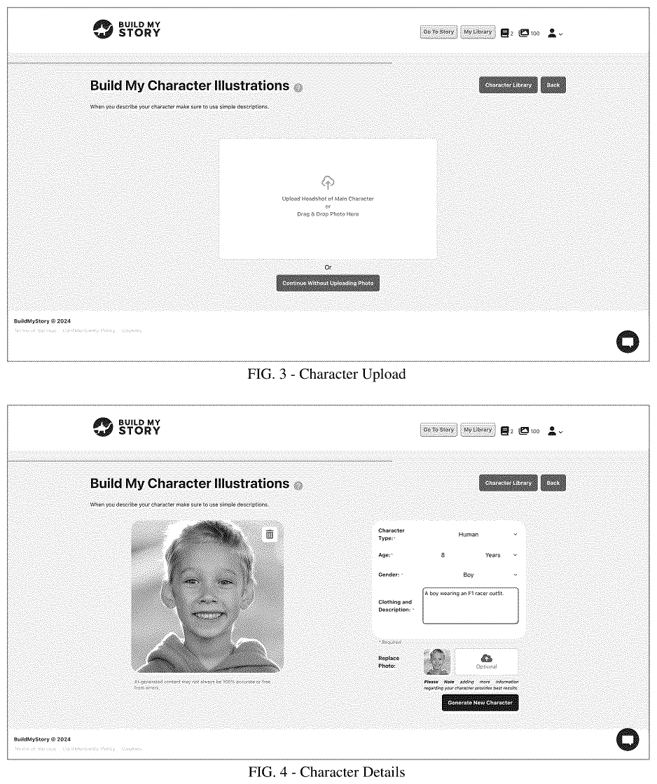

Turning to FIG. 3, Users can use the Select/Build Character interface 102 to choose to build a new character or select one from their existing User Character Library 104. First-time users start without preexisting characters, while returning users can access their saved library. The “Build Character” option allows users to upload a reference image or continue without one, offering a versatile approach to character creation. The Generate New Character interface 106 allows users to upload a reference image for guidance or to simply skip this step. The system employs asynchronous processing to generate four variations in real-time, displayed on a white background for clarity. Variations are derived based on predefined criteria and user inputs, ensuring creative flexibility while adhering to specifications.

Turning to FIG. 4, the Upload Reference Image interface 108 enables users to upload a reference image to guide the system in character generation. The system ensures alignment between the uploaded image and the generated character by leveraging an image API's templates such as, for example, those from ImagineAPI.dev's template capabilities, (ImageAPI.dev is an example of an online freely available image API) using the reference image as a base. The Criteria Selection interface 110 allows users to specify predefined criteria such as Character Type (Human, Fictional, Animal), Age, and Gender. This combination of inputs enhances character consistency and supports dynamic adjustments during generation.

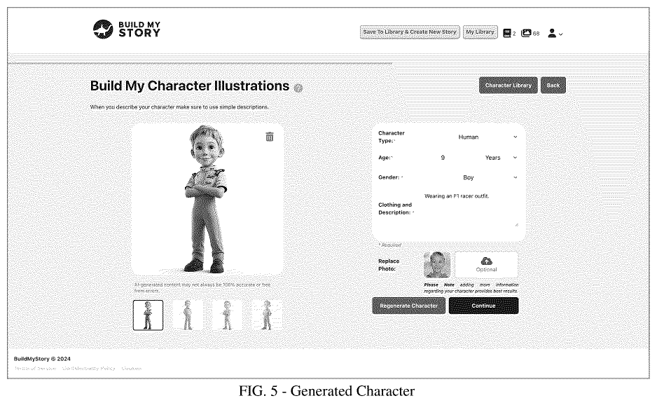

Turning to FIG. 5, the Generate Character module 112 enables the system to generate four character variations based on uploaded references and selected criteria. These options are presented to the user for selection, ensuring alignment with expectations while maintaining flexibility. In some embodiments, the process can leverage ImagineAPI.dev's proprietary algorithms, designed to reflect the likeness of uploaded references.

Turning back to FIG. 3, the Continue Without Uploading Image interface 114 allows users to choose to continue without uploading a reference image. In this case, the system generates the character entirely based on the provided description. This feature ensures flexibility and accessibility for users without visual references.

Turning back to FIG. 2, the Select Your Character from Character Library interface 116 allows users to select finalized characters from their User Character Library 104. The selected character is then seamlessly integrated into the story-building process, ensuring consistency and continuity.

With reference to FIG. 15, the master prompt 100, 102, 104, 116 consolidates all user inputs, including story details, character attributes, and user criteria into the story builder 124 via data flow connector 118. It is built dynamically throughout the workflow and sent to external AI systems for generating storylines and corresponding image prompts. By fine-tuning The generative AI's parameters, the system ensures consistent, high-quality outputs aligned with user preferences. For example, dynamic controls such as temperature encourage creativity, while presence penalty ensures novel storylines remain fresh and engaging.

Data is transferred from the Continue Without Uploading Image interface 114 to the Generate Character module 112 via a data flow connector 120 that manages the flow of character data, ensuring smooth transitions between steps. The finalized master prompt is transferred to the Story Builder 124 via the data flow connector 122, where it forms the basis for creating and editing the story.

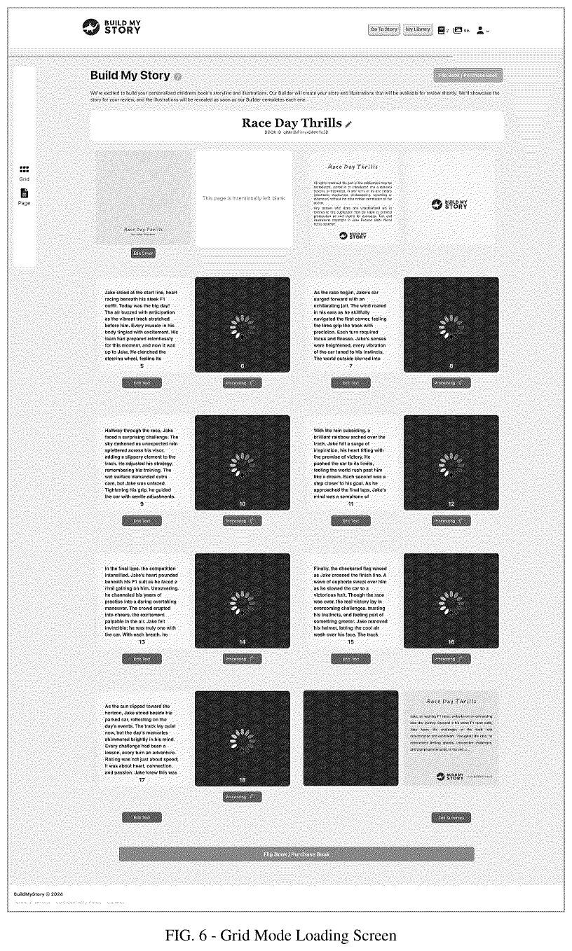

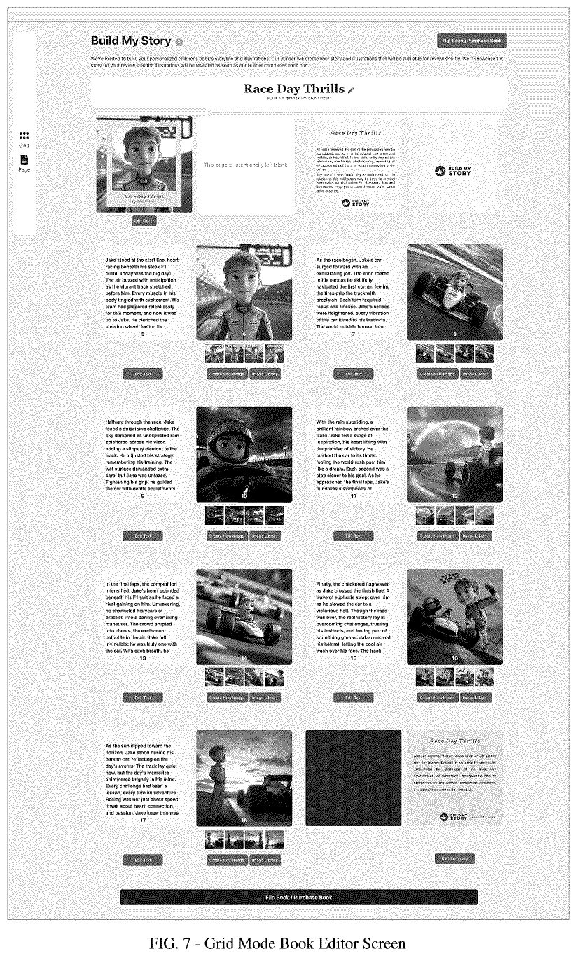

Turning to FIGS. 6 and 7, using a grid layout, the Story Builder 124 allows users to create and refine their story, integrating real-time updates from text and image data streams. Text loads instantly across pages, while placeholders for images are concurrently displayed with progress animations. These placeholders update dynamically as image data is processed in parallel, in real-time. In some embodiments, the system uses a mobile and web app development platform, e.g., such as Firebase commercially available from Google, to ensure updates are immediate, while asynchronous ImagineAPI.dev requests enable real-time generation. In some embodiments, users are notified of progress via webhooks and updates pulled from Firebase.

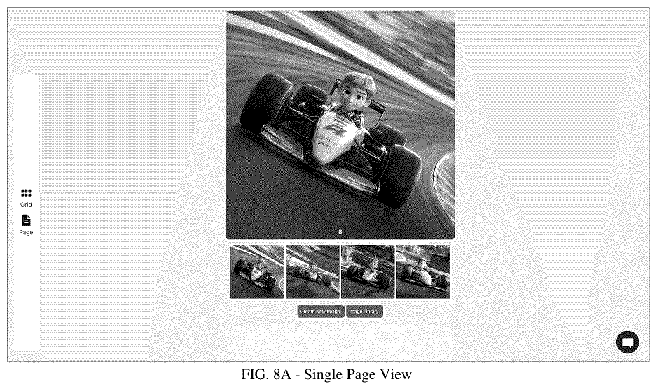

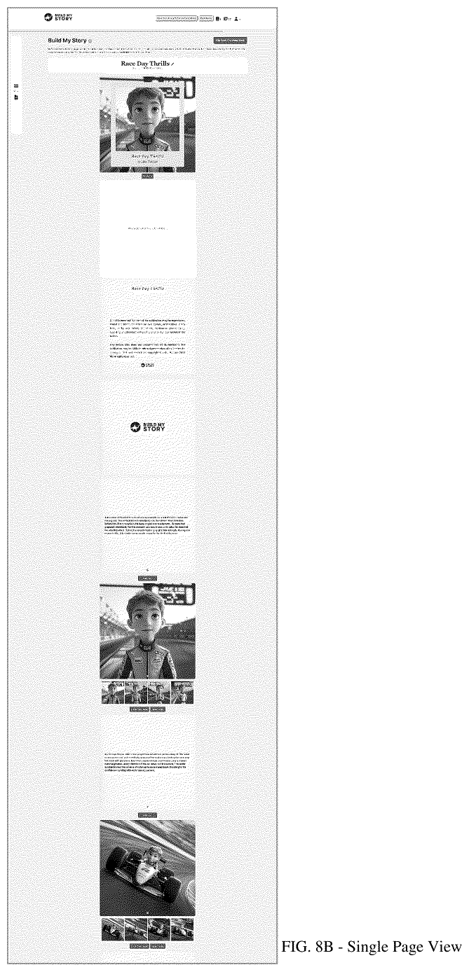

Turning to FIGS. 8A and 8B, the Page View interface 126 allows users to focus on individual pages, providing detailed GUI controls for text editing and illustration adjustments. The dynamic tone and narrative adjustments are guided by the generative AI's contextual optimization, such as age-specific tone settings and character portrayal parameters. These adjustments maintain consistency across all story elements by factoring in attributes like the character's age, type, and description.

The Grid View 128, as depicted in FIGS. 6 and 7, displays several or all story pages concurrently, including real-time placeholders and loading animations for illustrations as the illustrations are being rendered in parallel. In some embodiments, the illustrations can be rendered serially. Centralized state management using a library (i.e., a Java Script library) for predictable and maintainable global state management (i.e., Redux available from Dan Abramov at https://redux.js.org/) ensures consistent data handling and synchronization between text and images. Data is optimized with memorized selectors to prevent unnecessary re-renders, improving speed and user experience. In some embodiments, Redux DevTools can be used for debugging state changes and optimizing the grid's real-time updates.

As shown in FIG. 15, the data transfer from the Image Editor Interface 136 to the Generate new Character interface 106 is via data flow connector 130. This connector 130 facilitates the addition of new characters mid-process, redirecting users to the character creation workflow without disrupting the story-building flow. In addition, data created in the generate character module 112 is transferred to the Image Editor interface 136 for further refinement via data flow connector 132, maintaining a seamless workflow.

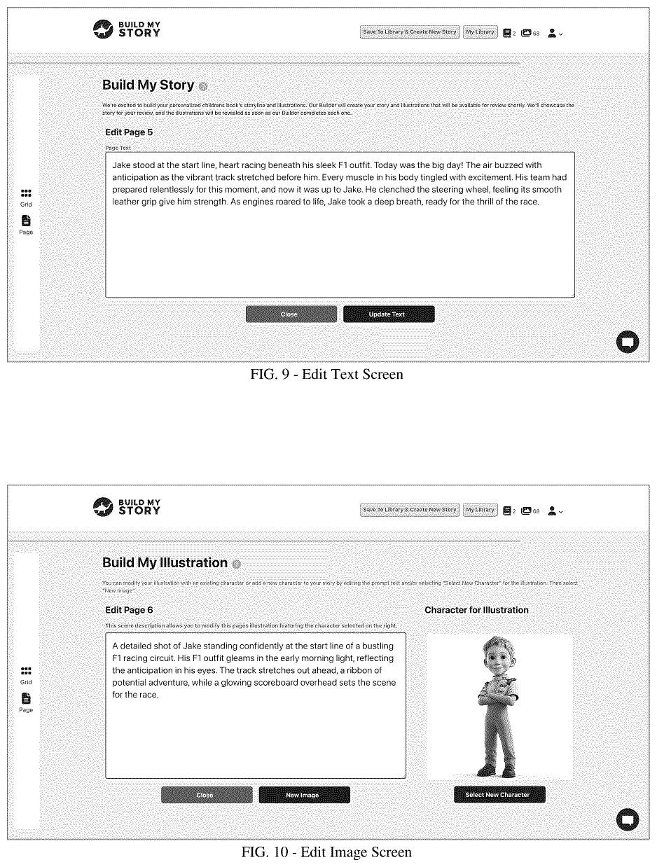

Turning back to FIG. 9, the Text Editor Interface 134 enables users to refine and format text. Dynamic adjustments to tone and text size can be determined via the AI (e.g., ChatGPT), based on reading level and user preferences. These adjustments ensure the story remains contextually appropriate and engaging for the target audience.

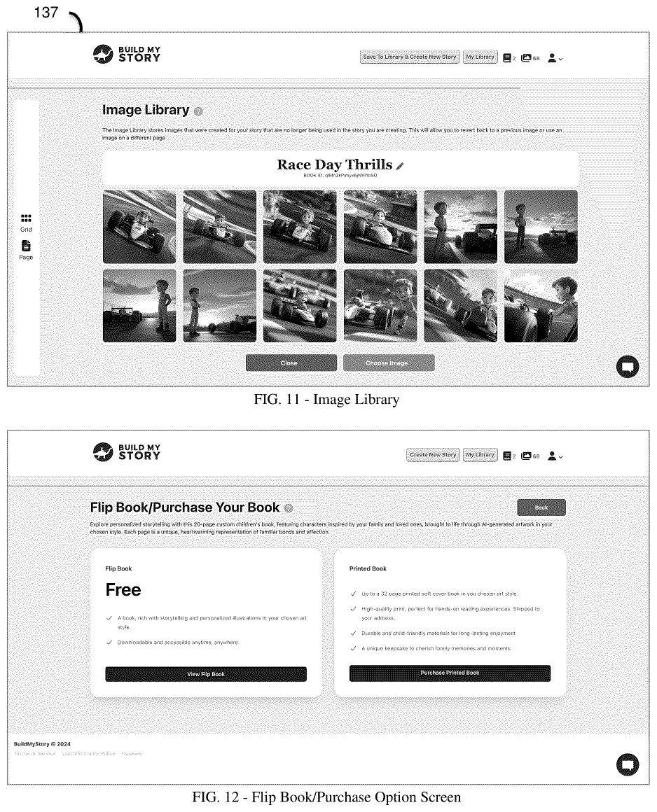

Turning to FIG. 10, the Image Editor Interface 136 allows users to refine generated illustrations. Edits are made via text prompts that reference the selected character and scene context. New characters can also be added mid-process, seamlessly re-entering the character creation workflow. FIG. 11 depicts an Image Library user interface 137 that enables easy access to and selection of the individual images of the story for editing in the Image Editor Interface 136.

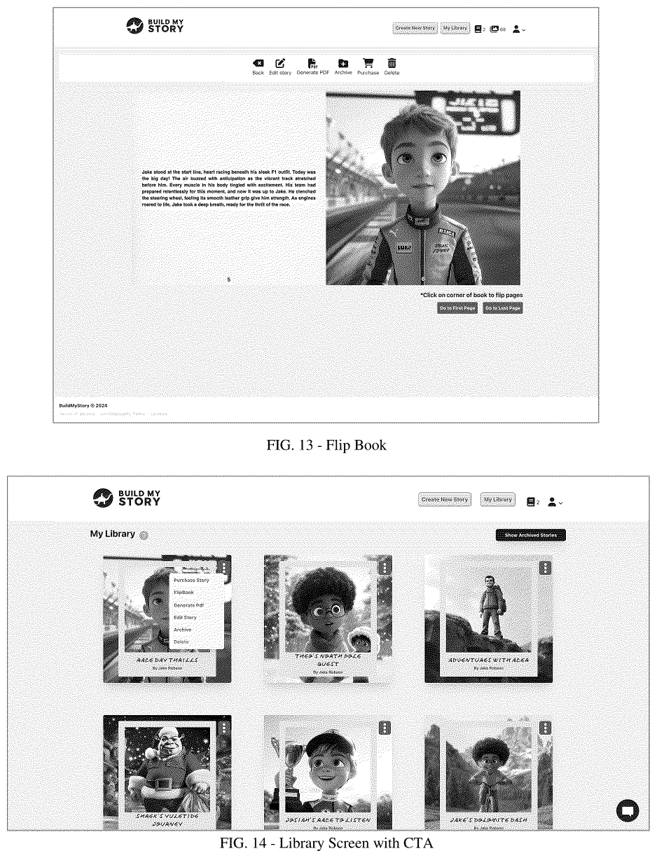

Flow continues to the Flip Book/Purchase Book module 138 as shown in FIG. 16 and an example embodiment is depicted in FIG. 12. The Flip Book/Purchase Book module 138 presents the completed story in an interactive format, combining text and illustrations for a cohesive preview. Users can intuitively transition from preview to purchase via a clean interface. The system also stores Flip Book configurations, enabling retrieval for later viewing or sharing. In some embodiments, the Flip Book is available for free, allowing users to interactively preview the story via the view flip book interface 140, an example of which is depicted in FIG. 13. While edits cannot be made in this mode, call-to-action buttons enable users to archive, purchase, or generate a PDF of the book. Users finalize their purchase by selecting the “Buy Now” option 142. Secure payment processes ensure user confidence and accuracy. Upon purchase confirmation in Purchase Book Module 144, the system processes the order and prepares the book for production. In the Print Book module 146, the book is printed in the selected format and dispatched for delivery. The system guides users through secure payment steps 150, displaying transaction details and relevant notifications. Upon payment completion 152, the system provides confirmation through the interface and stores the receipt in the user's library.

As depicted in the example View My Library interface 154 of FIG. 14, the library stores metadata such as “last edited date” for each book, enabling users to organize and revisit drafts or completed works. While version control is not implemented, users can sort by date or archive unwanted books. The system's notifications for progress tracking ensure real-time updates on book deliveries. Finalized book data is transferred via data flow connector 156 to the tracking and delivery system. Users receive updates on their book's delivery progress, ensuring transparency and satisfaction.

What is claimed is:

1. A method of generating a multi-page book customized to a user specified subject, the method comprising:
providing an interface adapted to prompt the user to supply data specific to the user specified subject;
generating and rendering pages of the book based on the data concurrently in parallel while displaying an interface depicting placeholders for each image of the different pages with progress animations;
updating dynamically in real-time the placeholders concurrently as image data is processed in parallel; and
providing an interface to edit the pages once rendered.

2. The method of claim 1 wherein the interface depicting placeholders for each image of the different pages with progress animations are arrayed in a grid.

3. The method of claim 1 wherein providing an interface adapted to prompt the user to supply data specific to the user specified subject includes prompting the user for information that can be used to generate images of the user specified subject.

4. The method of claim 1 wherein updating the placeholders includes layering additional details into the images.

5. The method of claim 1 wherein providing an interface to edit the pages includes concurrently presenting a text editing pane and an image editing pane side by side.

6. The method of claim 1 further comprising presenting an image library adapted to allow the user to organize and select images for editing.

7. The method of claim 1 wherein displaying an interface depicting placeholders for each image of the different pages with progress animations that include displaying status information.

8. A computer-implemented system for generating a multi-page book customized to a user specified subject, the system comprising:
a processor adapted to execute instructions; and
a memory coupled to the processor and adapted to store instructions to:
provide an interface adapted to prompt the user to supply data specific to the user specified subject;
generate and render pages of the book based on the data concurrently in parallel while displaying an interface depicting placeholders for each image of the different pages with progress animations;
update dynamically in real-time the placeholders concurrently as image data is processed in parallel; and
provide an interface to edit the pages once rendered.

9. The system of claim 8 wherein the interface depicting placeholders for each image of the different pages with progress animations are arrayed in a grid.

10. The system of claim 8 wherein the interface adapted to prompt the user to supply data specific to the user specified subject includes a prompt to the user for information that can be used to generate images of the user specified subject.

11. The system of claim 8 wherein the placeholder updates include additional details layered into the images.

12. The system of claim 8 wherein the interface for editing the pages includes concurrently presenting a text editing pane and an image editing pane side by side.

13. The system of claim 8 further comprising an image library adapted to allow the user to organize and select images for editing.

14. The system of claim 8 wherein the interface depicting placeholders for each image of the different pages includes update status information.

15. A user interface for generating a multi-page book customized to a user specified subject, the user interface comprising:
a display adapted to prompt the user to supply data specific to the user specified subject;
a display depicting pages of the book rendered based on the data concurrently in parallel while displaying an interface depicting placeholders for each image of the different pages with progress animations;
a display of the placeholders that is dynamically updated in real-time concurrently as image data is processed in parallel; and
an interface to edit the pages once rendered.

16. The user interface of claim 15 wherein the display depicting placeholders for each image of the different pages with progress animations are arrayed in a grid.

17. The user interface of claim 15 wherein the display adapted to prompt the user to supply data specific to the user specified subject includes a prompt to the user for information that can be used to generate images of the user specified subject.

18. The user interface of claim 15 wherein the placeholder updates include additional details layered into the images.

19. The user interface of claim 15 wherein the interface for editing the pages includes a text editing pane and an image editing pane concurrently presented side by side.

20. The user interface of claim 15 further comprising a display of an image library adapted to allow the user to organize and select images for editing.
